(19) United States
(12) Patent Application Publication
(10) Pub. No.: US 2003/0186610 A1
(43) Pub. Date: Oct. 2, 2003

(54) Elastic hydrophobic/hydrophilic composite yarns and moisture management elastic fabrics made therefrom

(76) Inventors: Tim Peters, Skillman, NJ (US); William L. Fay SR., Scituate, MA (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/113,286

(22) Filed: Apr. 2, 2002

(51) Int. Cl. D04B 1/00; D04B 7/00; D04B 9/00; D04B 11/00; D04B 21/00; D04H 1/00; D04H 3/00; D04H 5/00; D04H 13/00; D02G 3/00; B32B 5/16; D04H 3/16

(52) U.S. Cl. 442/327; 442/328; 428/364; 442/365; 442/335; 442/401

(57) ABSTRACT

A composite textile yarn and a moisture management elastic fabric made therefrom, the yarn comprising an elastic filament and hydrophilic fibers embedded at the yarn center within a matrix of hydrophobic fibers such that the hydrophobic fibers are concentrated at the periphery of the yarn, a transition area between the hydrophobic fibers concentrated about the elastic filament at the yarn center and the peripheral hydrophobic yarns in which both fiber types are present.

### RELATED APPLICATION

This application relates to pending application Serial No. ______ filed on even date herewith, entitled Composite Yarns and Moisture Management Fabrics Made Therefrom, commonly owned herewith.

### BACKGROUND OF THE INVENTION

This invention relates in general to a class of composite elastic textile yarns for use in forming moisture management structured fabrics with elastic properties. More specifically, it relates to improved moisture management textile composite yarns comprising elastic filaments and hydrophilic fibers embedded together within a matrix of one or more hydrophobic fibers. Further, this invention relates to improved moisture management elastic fabrics and garments produced by the use of the aforementioned composite textile yarns alone or in combination with other yarns.

In recent years, “structured fabrics” (also referred to as “engineered fabrics”) have become very popular in many application areas of commercial interest. A particularly important subclass of such structured fabrics is referred to commonly as “moisture management” fabrics. In general, fabrics of this type utilize two or more fiber types in layered structures that are formed so that the two sides of the fabrics are distinctly different in character. In particular, each side of the fabric exhibits different performance characteristics and properties with regard to water and water vapor. The innermost layer, or the fabric side that comes into contact with the body of the wearer, is comprised substantially of hydrophobic fibers, while the outer layer is made up substantially of hydrophilic fibers.

Lightweight, two-sided fabrics for use in moisture management applications also can be produced by a special knitting technique that is referred to generally as “plated knitting”. In forming plated knit moisture management fabrics, both hydrophobic and hydrophilic yarns are fed to a single set of knitting needles in the knitting machine so that two disparate yarns pass through each single needle of the set. With careful control of the feed and positioning of the hydrophobic and hydrophilic yarns to maintain a clear register of the components, the resulting “plated” knit fabric will show only hydrophobic yarns on one side and hydrophilic yarns on the opposite side.

The principal end use application areas for moisture management fabrics are in active sportswear garments, work clothing, intimate apparel, exercise garments, and footwear. For uses in garments that contact the body of a physically active wearer, the moisture management fabrics act to prevent or minimize the collection of perspiration as a liquid against the body and in the interstices of the fabric layer next to the body of the wearer. The perspiration, in liquid or vapor form, leaves the skin surface and diffuses, or wicks, through the hydrophobic fibers and is absorbed by the hydrophilic fibers in the outer fabric layer. The perspiration that passes from the skin surface through the hydrophobic fibers is absorbed by the outer layer of hydrophilic fibers and, then, evaporated into the ambient atmosphere away from the body. The transport of moisture from the body of the wearer to the atmosphere in this manner increases the comfort level of the garment to the wearer by preventing or minimizing the formation of wet areas at the skin surface or in the fabric layer nearest the skin. Further, by avoiding the collection of liquid perspiration at the body surface and in the fabric next to the body, the insulating value of the garment is improved so that it feels warmer at low temperatures and cooler, due to an evaporative cooling effect, at higher ambient temperatures to the wearer.

For many moisture management fabric applications, particularly in the areas of active sports and physical exercise wear, it is desirable that the moisture management garments exhibit a certain degree of elasticity with good recovery forces. This elasticity allows the garments to conform closely to the body contours of the wearer and to quickly adjust to rapid movements.

Most moisture management fabrics, based on prior art technology, are made on warp or circular knitting equipment. Hydrophobic fibers of choice generally are polyester, nylon, or polypropylene. These fibers may be in the form of staple yarns, flat continuous multifilaments, or texturized continuous multifilaments. For the hydrophilic side of the fabrics, the most popular fibers are based on modified nylon polymers. In general, such nylon polymers have been modified during the polymerization step by the addition of hydrophilic sites as segments within the nylon polymer chain and/or by adding the hydrophilic sites as branches to the nylon polymer chain. Alternatively, nylon may be made hydrophilic by subjecting the fibers to chemical reactions that serve to add hydrophilic sites to the finished nylon polymer. This approach, however, is not in common use. Other less popular hydrophilic fibers are based on modified polyvinylalcohol and acrylic polymers. Here again, the hydrophilic fibers may be in the form of staple yarns, flat continuous multifilaments, or texturized continuous multifilaments.

For moisture management elastic fabrics, bare, core spun, or covered spandex (an elastic filament based on a urethane polymer) filaments are knit or woven into the structures referred to in the foregoing. A natural or synthetic elastic rubber thread can be used to provide elasticity to a moisture management fabric. Due to poor mechanical and aging properties of the natural and synthetic rubber formulations, however, such threads are rarely used in quality fabrics and garments.

The driving force, which causes the transport of water from perspiration as liquid and vapor by the process described in the foregoing, is sometimes referred to as a “push-pull” effect. That is to say, perspiration is repelled by the layer of hydrophobic fibers and “pushed”, or “wicked”, into the layer of hydrophilic fibers, where it is absorbed or “pulled” away. Actually, the movement of moisture from the skin to the outer atmosphere is driven by the large difference in humidity between the inner layer against the skin of the wearer and the ambient atmosphere. Further, the movement is facilitated and directed away from the body by the structured arrangement of hydrophobic and hydrophilic fibers.

Although elastic moisture management elastic fabrics can be produced on weaving looms, most commercially interesting fabrics of this type are knits that are produced either on warp or circular knitting equipment. As in the case of the non-elastic fabrics aforementioned, the hydrophobic fibers of choice generally are melt-spun from polyester, nylon, or polypropylene polymers. These fibers may be in the form of staple yarns, flat continuous multifilaments, or texturized continuous multifilaments. Again, as with the non-elastic fabrics, the most popular fibers in use the hydrophilic side of the elastic fabrics are based on modified nylon polymers. In general, such nylon polymers are provided with a hydrophilic nature by causing chemical modifications to the nylon polymer chain during the polymerization step. This is accomplished by the chemical addition of hydrophilic sites as segments within the nylon polymer chain or by the chemical attachment of hydrophilic sites as branches to the nylon polymer chain. Alternatively, nylon fibers may be made topically hydrophilic by subjecting the fibers to chemical reactions that serve to attach hydrophilic sites to the nylon polymer at the surface, or very near to the surface, of the fibers. Other less popular hydrophilic fibers are produced from modified polyvinylalcohol, acrylic, and cellulose acetate polymers. Here again, the hydrophilic fibers may be in the form of staple yarns, flat continuous multifilaments, or texturized continuous multifilaments. In some cases, cotton and modified cotton yarns also are used as the hydrophilic component.

Spandex continuous filaments, which are produced by dry or wet spinning dimethylformamide or dimethylacetamide solutions of polyester or polyether based urethane polymers, are the preferred elastic filaments.

Even though the elastic moisture management structured fabrics of the prior art have been well received in the marketplace, they have a number of disadvantages, which limit their utility in certain applications. One of the more important problem areas involves the need to use a minimum of three yarns with knitting or weaving equipment that is capable of producing fabrics with two distinct sides. For warp knitting, it is necessary to use knitting machines with a minimum of 3 needle bars rather than the more commonly available and higher speed 2 needle bar machines. The need to use such specialized equipment results in rather high cost for the products. Examples of other problem areas are summarized in paragraphs that follow.

In general, there are significant differences in dyeability and dye fastness properties between the elastic filaments and the hydrophilic and hydrophobic fibers that are used in a particular moisture management structure. Due to such differences, it can be very difficult and, at times, even impossible to produce a dyed fabric of uniform coloration. For some cases, three or more dye types, as well as multiple dyeing cycles, must be employed in order to obtain acceptable results. This can increase substantially the dyeing and finishing costs for moisture management fabrics.

As aforementioned, moisture management elastic fabrics based on the prior art are formed so that the fabric side, which is in contact with the skin surface of the wearer, is hydrophobic, while the outer fabric surface contains the hydrophilic fibers. For good elastic behavior, elastic filaments often must be knit or woven into both the inner and outer layers of the fabric structure. This creates a serious problem in certain important applications for the moisture management elastic fabrics. It is a problem, particularly in the area of active sportswear and promotional items where the outer garment surfaces frequently are screen or transfer printed with names, logos, and other bold design features. Serious problems can occur because the preferred elastic filaments and the hydrophilic fibers based on modified nylon polymers perform very poorly as substrates for the dyes and inks commonly utilized in screen and transfer printing. Consequently, it is either impossible or costly to print a broad range of bright colorful designs onto moisture management fabrics based on prior art technology.

The foregoing problem may be avoided to a certain extent by the use of plated-knit techniques in which three yarns are fed to the same needle set of the knitting equipment to produce an elastic fabric. This prior art technique is referred to as “sandwich-plated knitting”. In producing a printable elastic fabric, a hydrophilic yarn is sandwiched between two hydrophobic yarns. The 3-yarn sets, then, are fed to a single set of knitting needles and elastic filaments, either bare or covered, are fed through a separate needle set. The resulting fabric has hydrophobic fibers, which will accept screen or transfer prints, at both surfaces. Although this approach does produce a printable moisture management elastic fabric, it is a difficult technique in practice, since three yarns must be fed through a needle entrance guide and into each single needle in a fixed order and in precise register. Further, the disparate yarns easily can slip out of register in production and usage. This loss of precise register in the sandwiched yarn structure leads to blurred prints.

Mechanical properties, including abrasion resistance, normally are lower for the preferred elastic and the hydrophilic fibers based on modified nylon polymers than they are for the more commonly used hydrophobic fibers, such as the polyesters, unmodified nylons, and polypropylenes. This can complicate knitting and limit application areas in which the elastic moisture management structures can be used successfully.

The tactile properties of the commonly used elastic filaments and the hydrophobic and hydrophilic fibers generally differ substantially. As a result, the “hand” or “feel” of an elastic moisture management structured fabric can be quite different, depending on the fabric surface that is touched. This can be a serious disadvantage in certain applications, such as intimate apparel.

U.S. Pat. No. 4,621,489 to Hozuma Okada, discloses a sheath/core yarn comprising a thread wadding of inner hydrophilic fibers, and a thread sheath of outer hydrophobic fibers. The wadding can include a polyurethane elastic yarn such as spandex with the hydrophilic fibers wound about the spandex.

### SUMMARY OF THE INVENTION

The principal objective of this invention is to provide a structured elastic composite yarn with both hydrophilic and hydrophobic properties that can be used alone or in combination with other hydrophobic yarns to produce highly efficient moisture management elastic fabrics. A further objective is to employ a composite elastic yarn comprising an elastic filament and hydrophilic fibers imbedded within a matrix of hydrophobic fibers, either alone or in combination with one or more hydrophobic yarns, to form knit and woven moisture management fabrics. The resulting moisture management elastic fabrics, while managing moisture as well as, or better than, prior art fabrics, substantially overcome the aforementioned deficiencies that limit the utility of elastic moisture management yarns and fabrics, which are based on the prior art.

The present invention satisfies the foregoing objectives by providing a composite yarn made up of 3 or more components. A continuous elastic filament is located centrally within the composite yarn and is substantially surrounded by a hydrophilic multifilament yarn. The elastic filament and the hydrophilic yarn together are fully imbedded within a matrix of one or more hydrophilic multifilament or staple yarns. The composite elastic yarn is formed so that there is an annular area within the yarn cross-section in which there is a commingling of hydrophilic and hydrophobic fibers. This area of commingling is positioned between the periphery of the composite where hydrophobic fibers are concentrated and the area encompassing the yarn center where hydrophilic fibers are concentrated about the elastic filament.

When in a garment against the skin surface of a wearer, this unique composite elastic yarn structure leads to an efficient and rapid wicking effect of perspiration moisture from the outer hydrophobic fibers in contact with the skin surface to the inner hydrophilic fibers of the yarn. On the garment surface away from the body of the wearer, the moisture evaporates from the inner hydrophilic fibers and passes through the outer hydrophobic fibers to the atmosphere.

Although a variety of yarn processing equipment, after some modifications, may be utilized in producing the unique composite elastic yarns described in the foregoing, air-jet texturing equipment is particularly useful. Such equipment forms the composite elastic yarns by subjecting combinations of the component yarns to violent forces that are generated by compressed air or steam within a texturing cavity. Relative feed rates of the component yarns, air pressures, the geometry of the air jet and cavity, heat setting conditions, and take up tensions control the position of the diverse fiber components, area of commingling of hydrophobic and hydrophilic fibers, the degree of commingling, and the overall morphology in the composite elastic yarn produced. With conditions under optimum control, the composite yarn exiting the air texturing or entanglement machine has hydrophilic fibers and the elastic filament concentrated substantially at its core, while the hydrophobic fibers are concentrated substantially at its periphery. There is no sharp interface or demarcation area separating the hydrophobic surface fibers from the centrally concentrated hydrophilic fibers in the resulting composite yarn. Rather, an area within the cross section that is made up of commingled hydrophilic and hydrophobic fibers separates the hydrophobic fibers concentrated at the periphery of the composite yarn from the hydrophilic fibers concentrated near the center of the composite elastic yarn about the elastic filament.

It has been found that the presence of intimately commingled hydrophobic and hydrophilic filaments within the cross-section of the composite yarn cross section leads to a more rapid transference of moisture through the peripheral hydrophobic fibers and into the centrally concentrated hydrophilic fibers as compared to conventional sheath/core composite yarns prepared, for example, according to the teachings of the aforementioned Okada patent. In like manner, the area of intimate commingling of hydrophilic and hydrophobic fibers accelerates the transfer of moisture in the vapor form from the inner hydrophilic fibers through the hydrophobic fibers and into the atmosphere.

The area within the yarn cross-section wherein hydrophilic and hydrophobic fibers commingle is critically important to the superior performance in moisture management fabrics of the composite elastic yarns of the invention. This can be understood by a comparison with the sheath/core moisture composite yarns of the prior art in which the hydrophilic core yarn is tightly wrapped by hydrophobic fibers. In such yarns, the area of the interface between hydrophobic fibers and hydrophilic fibers is proportional to the square of the radius of the hydrophilic bundle of fibers at the core. For the composite elastic yarns of the invention, commingling of the individual filaments of hydrophobic and hydrophilic fibers results in a substantially larger interface area. This increase of the interface area occurs because the interface within the commingling area of the composite elastic yarn is proportional to the square of the radii of the much finer individual monofilaments of the hydrophobic and hydrophilic yarns. An increase in the area of the interface between hydrophobic and hydrophilic components does not increase the total amount of moisture that can be taken up by the composite elastic yarn. An increase in interface, however, increases the kinetics of absorption so that moisture transfer becomes more rapid and effective in the moisture management fabric.

When used in a two-sided moisture management elastic fabric, the composite elastic yarn of the invention replaces the hydrophilic yarn that would be positioned in the outer fabric surface of a moisture management fabric based on prior art technology. The resulting fabric has an inner surface made up of hydrophobic yarn, while the opposite side is made up of a composite elastic yarn of the invention alone, or in combination with, a hydrophobic yarn. In a moisture management elastic garment, or other end use articles, in contact with the body of a wearer, moisture from perspiration passes from the skin surface through the hydrophobic fibers of the inner fabric layer and, then, through the peripheral hydrophobic matrix fibers and into the inner hydrophilic fibers of the composite yarn in the outer layer. Finally, in the outer layer, the moisture evaporates from the hydrophilic fibers, passes through the hydrophobic peripheral fibers of the composite yarn, and into the atmosphere. The elastic filament provides elastic properties to the fabric and is substantially uninvolved in moisture transport.

By utilizing the unique hydrophilic/hydrophobic composite elastic yarns of the invention in the production of moisture management elastic fabrics and garments, the problems associated with elastic products based on prior art technology, described in the foregoing, are avoided. The reasons for these marked improvements are summarized in brief by the following paragraphs.

With clear, dull, or neutral colored elastic filaments and hydrophilic fibers embedded within matrices of hydrophobic fibers in composite elastic yarns of the invention, it is possible to dye only the hydrophobic fibers and leave the elastic filament and the hydrophilic fibers undyed, since they will be substantially concealed by the outer hydrophobic fibers. Also, if a fiber such as polyester is utilized as the hydrophobic component, it will be at the yarn and fabric surface where it will accept readily screen and transfer prints in contrast to the problems associated with prior art fabrics that have hydrophilic yarns on the outer surface. Further, there are no register problems as can occur in the plated sandwich knits of the prior art.

For the reason abovementioned, fabric tactile properties will be dependent primarily on the hydrophobic fiber at the surface of the composite yarn without the need to resort to the plated sandwich knits based on the prior art. Similarly, mechanical properties of fabrics, such as abrasion resistance, will be controlled by the hydrophobic component of the composite yarn at the surface of the fabric structure.

An additional advantage for the invention over prior art technology is that the unique character of the composite elastic yarns based thereon permits the production of moisture management elastic fabrics from a single composite yarn. This feature of the invention allows the use of simpler knitting equipment and procedures than are possible when using three or more disparate yarns as are required by the technology disclosed in the prior art. Such single-yarn moisture management elastic fabrics that are produced by using composite yarns of this invention have the same hydrophobic fibers exposed on both sides. In a garment, hydrophobic fibers are in intimate contact with the body of the wearer. Perspiration is wicked rapidly into the interstices of the composite yarn where it is absorbed by the hydrophilic fibers imbedded within the hydrophobic fiber matrix. The moisture, then, is transmitted through the hydrophilic fibers to the outer fabric surface, where it evaporates from the hydrophilic fibers and the vapor passes through the outer hydrophobic fibers to the atmosphere.

The elastic composite yarns of the invention are particularly useful in the production of two-sided moisture management fabrics similar in structure to fabrics based on prior art technology. In such fabrics utilizing composite yarns of the invention, however, the elastic composite yarn replaces the hydrophilic yarn that would be used, according to the prior art, in the outer layer of the fabric that is away from the body of the wearer in a finished garment.

Depending on the effect desired in the structured moisture management elastic fabric and in the end use garment, the elastic composite yarns of the invention may be utilized, alone or in combination with hydrophobic yarns, for both sides of the two-sided fabric. When composite yarns of the invention are used in producing two sided fabrics, hydrophobic fibers are at the surface of both the inner layer and outer layer of the finished fabric. As a result, transfer or screen printing can be done on either or both fabric sides so that prints in complex designs and bright, sharply-defined colors can appear on either or both surfaces of the finished garment, without the complications associated with screen and transfer printing onto surfaces made up primarily of hydrophilic fibers, such as the modified nylon based fibers.

These and other objectives, features, and advantages of the present invention will become apparent upon reading the following detailed description and claims and studying the drawings.

### BRIEF DESCRIPTION OF THE DRAWINGS

FIG. 1 is a typical distribution of the hydrophobic/hydrophilic fibers and the elastic filament in an elastic composite yarn of the invention by a sketch of an enlarged view of a yarn cross section taken at a right angle to its longitudinal axis.

FIG. 2 presents an enlarged view of a typical distribution of hydrophobic and hydrophilic fibers along with the elastic filament within a composite elastic yarn of the invention by a sketch of a side view along the longitudinal axis of the yarn structure.

FIG. 3 is an enlarged view of the elastic composite yarn of the invention plied with a yarn of hydrophobic filaments.

FIG. 4 is an enlarged view of the elastic composite yarn of this invention plied with two hydrophobic yarns.

FIG. 5 is an enlarged plan view of a plain knit moisture management elastic fabric formed by utilizing only a single composite elastic yarn based on the invention to produce a structure in which the two sides are substantially identical.

FIG. 6 is a representation in schematic form of typical pathways for the elastic filament and the hydrophobic and hydrophilic fibers as they are processed on an air-jet texturing machine to produce the composite yarns of the present invention.

FIG. 7 is a representation in schematic form of typical pathways for the elastic filament, the hydrophilic multifilament yarn, and the hydrophobic staple fibers in sliver form as they are processed on a typical cotton spinning frame to produce the elastic composite yarns of the present invention by core spinning.

FIG. 8 is a representation in schematic form of typical pathways for the elastic filament, the hydrophilic multifilament yarn, and the hydrophobic multifilament yarn as they are processed on a typical elastic fiber covering machine.

### DETAILED DESCRIPTION OF THE INVENTION

The present invention provides a composite elastic yarn, comprising an elastic filament in combination with both hydrophobic and hydrophilic fibers, and moisture management elastic fabrics therefrom. Composite elastic yarns of the invention may be produced by several techniques using conventional yarn processing equipment with minimal modifications. One of the preferred processes utilizes air-jet texturing equipment. If such equipment is used under carefully controlled conditions, the resulting composite yarn has the elastic filament and the hydrophilic fibers positioned substantially at the longitudinal axis of the yarn and the hydrophobic fibers concentrated peripherally. The elastic filament is at or near the center of the composite yarn surrounded by a concentration of the hydrophilic fibers, while there is a commingling of both hydrophilic and hydrophobic fiber types within an intermediate area between the yarn center and its periphery.

With an added precision yarn feed, conventional elastic thread covering machines used in the production of covered elastic yarns may be utilized in forming the composite elastic yarns of the invention. When using covering machines, the hydrophilic yarn is fed under tension along with a stretched elastic filament through the covering spindles of the machine. The covering spindles wrap one or two covers of a textured hydrophobic yarn about the combined hydrophilic yarn and the elastic filament. Depending on the needs of the end use garment, an elastic filament can be fed alone through the covering spindles with the lower spindle loaded with a hydrophilic yarn and the upper spindle, with hydrophobic. The result is a composite elastic yarn with an elastic filament at its core, a hydrophilic yarn as the first cover, and a hydrophobic yarn as the outer cover.

In the two examples of the foregoing paragraph, it is necessary to use textured hydrophilic and hydrophobic yarns in order to assure an area of commingling within the composite elastic yarn.

The annular area within the composite elastic yarn cross-section in which hydrophilic and hydrophobic fibers commingle that is positioned between the inner hydrophilic fiber concentration and the peripheral concentration of hydrophobic fibers is an important and unique feature of the composite yarns of the invention. In a conventional sheath core composite there is a clear transition between hydrophobic and hydrophilic fibers within the yarn cross-section. As a result, the interface through which moisture must penetrate in crossing from the hydrophobic fibers to the hydrophilic fibers is very restricted. By providing an area of commingling of hydrophobic and hydrophilic fibers within the cross-section of the composite, the composite yarns of the invention greatly increase the area per unit length of the interface through which the moisture must penetrate to be absorbed by the hydrophilic fibers. This increase in interface area per unit length acts on the kinetics of moisture transfer to increase the moisture transfer rate and efficiency.

The invention also provides highly effective elastic moisture management fabrics made by using only an elastic composite yarn of the invention or by using a hydrophobic yarn with an elastic filament for the fabric side that will contact the body of the wearer and the elastic composite yarn of the invention for the fabric side away from the body of the wearer. Further, the invention provides highly effective moisture management elastic fabrics made by using only a composite yarn of the invention or by using a hydrophobic yarn for the fabric side that will contact the body of the wearer and the composite yarn of the invention plied with one or more hydrophobic yarns for the fabric side away from the body of the wearer. Similarly, a composite yarn of the invention may be plied with one or more hydrophobic yarns and used with or without other yarns in producing moisture management elastic fabrics.

Depending on the process used to form the composite elastic yarns of the invention and the intended end uses, the hydrophilic and hydrophobic fiber components of the composite yarn may be in the form of flat multifilament yarns, texturized multifilament yarns, or a spun staple yarns. The preferred elastic fiber is a continuous “fused multifilament” spandex based on a urethane polymer.

FIG. 1 represents an enlarged view of a typical cross sectional profile, taken at a right angle to the longitudinal axis of an composite elastic yarn 4 of the invention that is produced on an air jet texturing machine. The spandex fused multifilament 1 is shown near the center of the composite as a crosshatched circle. The hydrophilic filaments 2 are shown as shaded open circles, while the hydrophobic filaments 3 are shown as open circles without shading. As can be seen in FIG. 1, the hydrophilic filaments 2 are concentrated about the fused multifilament spandex 1 near the center of the cross section, and hydrophobic filaments 3 are concentrated to the periphery of the composite yarn. Hydrophilic and hydrophobic filaments are commingled at an intermediate cross sectional area between the composite yarn's center and its periphery with no clear interface between the two fiber types.

FIG. 2 represents an enlarged side view along the longitudinal axis of the composite yarn 4 of the invention produced on air texturing equipment. It shows hydrophilic filaments 2 concentrated about the elastic filament 1 at the yarn core and surrounded by a matrix of hydrophobic filaments 3. Similar to FIG. 1, FIG. 2 illustrates a commingling of hydrophilic and hydrophobic fibers in an intermediate area between the composite yarn's center and its outer surface.

Depending on end use applications, the percentage of hydrophilic fibers needed for optimum mechanical and comfort performance in the moisture management elastic fabric may vary from a low of 8 to 10 percent to a high of 50 to 60 percent by weight. The percentage of elastic filament and the amount of stretch to which it is subjected in forming the elastic composite yarn varies with the recovery power and elongation needed in the application area. In general, however, the minimum percentage of elastic fiber used is in the range of from 3 to 8 percent at the low side to a high of 25 to 30 percent based on the weight of the finished elastic fabric. Further, from an economic standpoint, it is desirable to avoid the use of more hydrophilic fibers or elastic filament in the fabric structure than the amount required for optimum moisture management and elastic performance, as the cost of these fibers is substantially higher than that for the hydrophobic fibers.

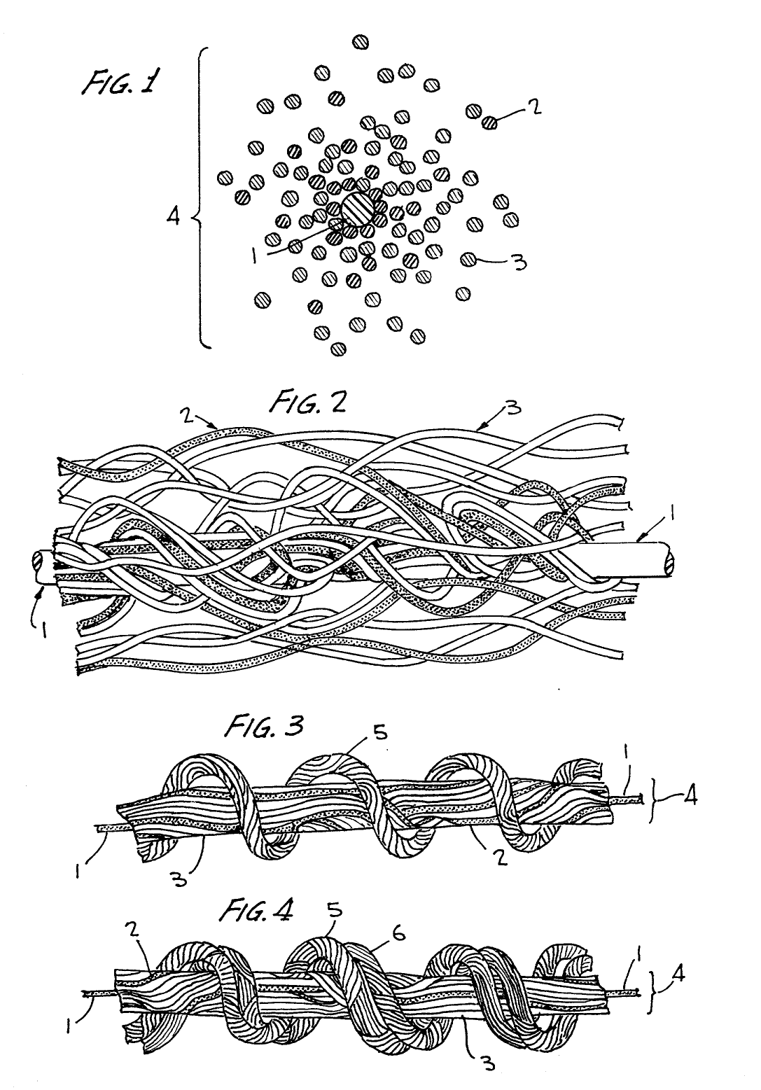

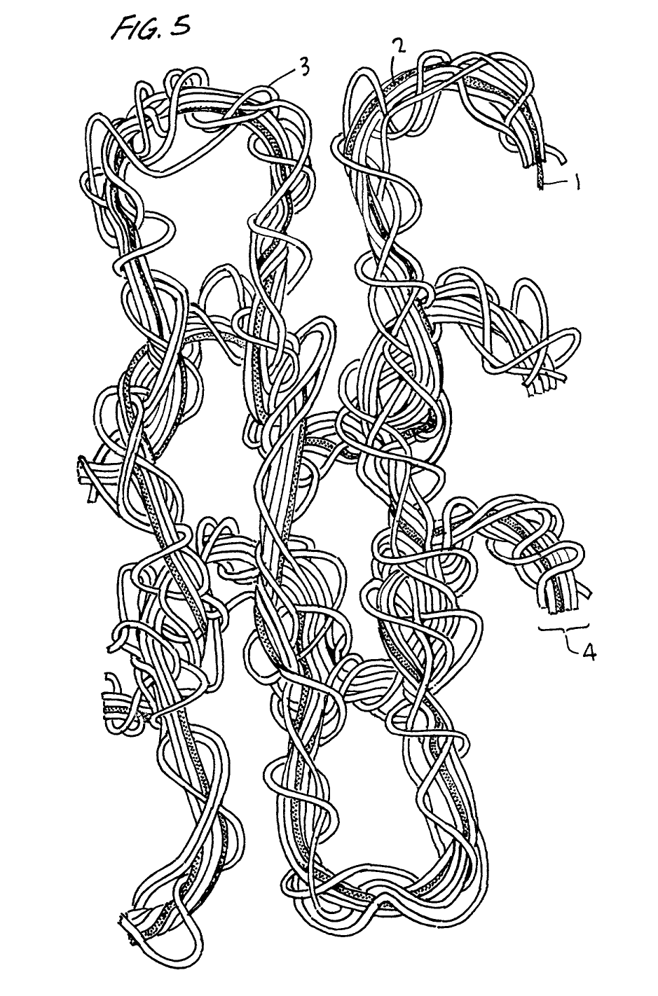

The hydrophilic fiber content in a moisture management elastic fabric of the invention may be varied by adjusting the ratio of hydrophobic to hydrophilic fibers used in the preparation of the composite elastic yarn of the invention. Similarly, elastic filament in the finished garment may be varied by adjusting the ratio of the elastic fiber weight to the combined weight of hydrophobic plus hydrophilic fibers. In practice, however, it frequently is more convenient and economical to produce a limited number of standard composite yarns of the invention with fixed hydrophilic fiber and elastic filament contents and, then, to adjust the hydrophilic yarn content and elasticity in the finished moisture management fabric by plying composite yarns with one or more hydrophobic yarns. FIG. 3 shows an enlarged side view of the elastic composite yarn 4 of the invention with both hydrophilic 2 and hydrophobic 3 fibers and a core elastic filament, plied with a continuous multifilament hydrophobic yarn 5. In like manner, FIG. 4 illustrates a magnified side view of a composite yarn 4 of the invention plied with two continuous multifilament hydrophobic yarns 5 and 6, each of essentially 100 percent hydrophobic fibers. The two hydrophobic yarns 5 and 6 may be identical or different, depending on the effect desired in the plied composite yarn and in the moisture management fabric. For example, one hydrophobic yarn could be based on polyester and the other polypropylene. Further, in order to obtain a fabric with a soft hand (i.e., a soft feel) and a high resistance to abrasion, the composite yarn of the invention could be plied with one polyester yarn comprising monofilaments of normal deniers in the range of 1.5 to 3, while the other would comprise micro monofilaments with deniers well below 1.

The hydrophilic fiber content in a moisture management fabric also can be adjusted by knitting alternate courses of the composite yarn of the invention along with courses of a hydrophobic yarn. Further, additional elastic filaments can be knit or laid-in with the composite yarn during knitting.

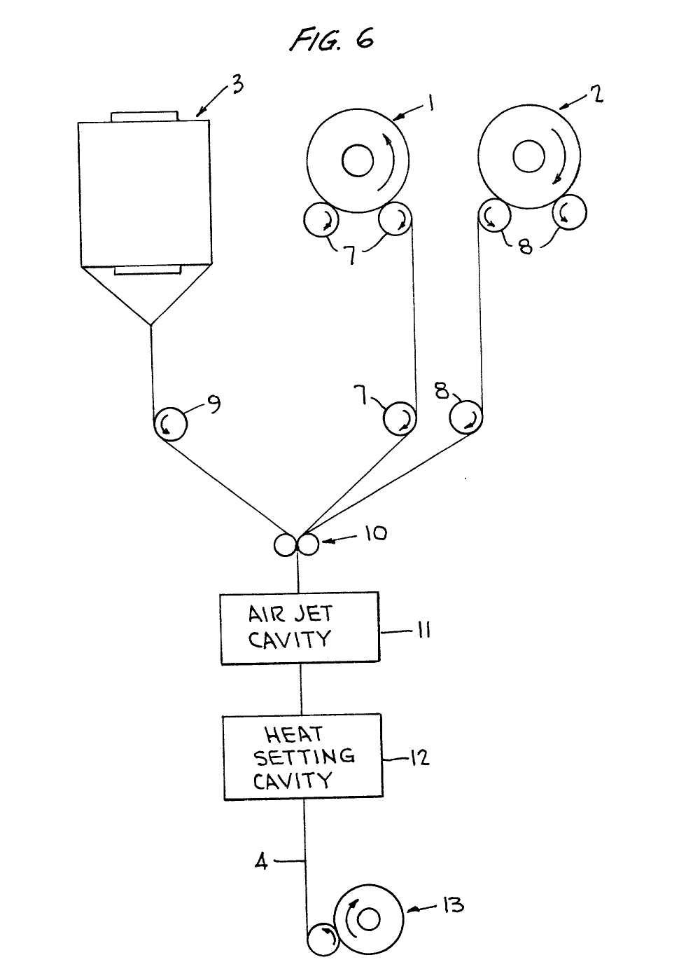

The sketch of FIG. 5 shows an enlarged plan view representation of a plain knit fabric produced from a single composite yarn 4 of the invention containing both hydrophilic 2 and hydrophobic 3 fibers along with an embedded elastic filament 1, which is occluded from view by the hydrophilic and hydrophobic fibers. Due to the unique properties of the composite yarn of the invention, such a simple fabric structure is effective in providing elasticity and in absorbing perspiration from the high humidity atmosphere at the skin surface of a wearer and, then, evaporating the absorbed moisture from the inner hydrophilic fibers through the hydrophobic matrix fiber at the opposite fabric side into the lower humidity at ambient conditions. Further, since the surfaces of both fabric sides are made up substantially of hydrophobic fibers, garments based on the single elastic composite yarn fabric readily accept screen and transfer printed designs on either or both sides.

The hydrophobic fibers of most interest for use in the composite elastic yarns of the invention have low moisture regain values. The preferred hydrophobic fibers for a majority of current end uses in moisture management fabrics and garments are derived from either polyester or nylon polymers. Other hydrophobic fibers that can be used in composite elastic yarns of the invention include fibers based on: polypropylene, polyvinylchloride, and polyacrylonitrile polymers. Although hydrophobic fibers based on polyester and, to a lesser extent, nylon polymers are preferred for most moisture management fabrics and garments of current commercial interest, the hydrophobic fiber actually chosen for use in a particular application must be selected on the basis of economics and the needs of the end use application.

The hydrophilic fibers for use in the composite elastic yarns of the invention must have high moisture regain values. The preferred hydrophilic fibers are based on modified 6- or 66-nylon polymers. A particularly useful modified 6-nylon fiber is supplied under the trade name “Hydrofil”. The AlliedSignal Co. was the original developer and supplier of this product; but it, now, is produced and supplied by Universal Fiber Systems, LLC. Other useful products based on a modified nylon product that can be used as the hydrophilic component for the composite yarns of the invention include fibers sold under the trade names of “Quup” and “Hygra”. Toray Nylon, Ltd. of Japan produces “Quup” in continuous multifilament form by melt extruding a modified 6-nylon. “Hygra” is also produced and supplied from Japan. It is a structured sheaf/core bicomponent fiber in which the outer surface of the individual continuous monofilaments are comprised of a hydrophobic 6-nylon, while the core is comprised of a hydrophilic modified 6-nylon. This fiber is produced and supplied by Unitika Fibers, Ltd. Other hydrophilic fibers of lesser interest include: cotton, cellulose acetate staple yarns and filaments, rayon, linen, modified acrylics, and modified polyvinylalcohols.

Although a number of natural and synthetic rubber elastic filaments are available commercially, the preferred elastic filaments for the composite yarns of the invention are based on polyester or polyether urethane polymers. Such urethane-based filaments are available from many suppliers worldwide under the generic names of “spandex”, in the USA and a number of other countries, or “elastane”, in the European Common Market and some other areas. The spandex products are preferred over the natural and synthetic rubber filaments because of their superior mechanical and aging properties.

As aforementioned, the composite elastic yarns of the invention comprise hydrophilic fibers along with an elastic filament embedded within a matrix of flat hydrophobic fibers. Depending on the effect desired in the finished product and the equipment used to form the composite yarn, the hydrophilic fiber might be in the form of flat continuous filaments, textured continuous filaments, or staple yarn. The hydrophobic matrix component also may be in the same or different form as the hydrophilic component. However, for most applications, a staple yarn would not be used for the hydrophobic component, since it would result in a product with rather low abrasion resistance. Also, a hydrophobic staple yarn would not be used when the composite yarn is produced using air-jet texturing equipment, as the violent air streams in the air-jet cavities of such equipment tend to disrupt staple spun yarns.

Although other approaches are possible, one of the preferred processes for producing composite yarns of the invention is to pass the two fiber types together through an air jet of the type commonly used in air jet texturing equipment. This process is particularly useful when a bulky low-density yarn is desired. The feed rates must be carefully controlled in order to assure a concentration of hydrophilic fibers toward the center around the elastic filament and the hydrophobic fibers toward the periphery of the resulting composite yarn. Further, it is very important to assure an area of commingling between the hydrophilic fibers concentrated toward the yarn center and the peripheral hydrophobic fibers. These objectives are accomplished by feeding the hydrophilic fibers under tension and the elastic filament at an elongation of 100 percent or more, while the hydrophobic fibers are overfed. In addition, air pressure as well as the air jet and jet cavity configurations must be carefully selected and controlled. Air jet yarn texturing machines of use in producing composite yarns of the invention are supplied by a number of textile equipment fabricators. Among these are ICBT in France, Staehle in Germany, and Menegatto in Italy. FIG. 6 illustrates typical elastic filament, hydrophilic yarn, and hydrophobic yarn pathways in an air jet-texturing machine.

In FIG. 6, a positive drive 8 feeds the hydrophilic multifilament continuous yarn 2 at a fixed rate and controlled tension through an entry guide 10 into the air jet cavity 11. A second positive drive assembly 7 feeds the elastic filament 1 at a controlled stretch into the same entrance guide 10 into the air-jet cavity 11. An overfeed assembly 9 pulls the hydrophobic multifilament yarn 3 over the end of the supply package and feeds it at a higher feed rate than that used for the hydrophilic yarn, through an entry guide 10 to the air-jet chamber 11. On exiting the air jet cavity 11 the composite yarn passes through a heat setting assembly 12. Finally, a winding assembly 13 takes up the composite yarn 4 onto a bobbin.

As the elastic filament 1, the hydrophilic 2, and the hydrophobic 3 yarns pass through the violent, high-velocity air stream maintained in the air jet cavity, 11 the hydrophilic monofilaments and the elastic fused filament substantially maintain their integrity, due to the controlled tension and elongation maintained by the feed control assemblies 7 and 8. The individual monofilaments of the overfed hydrophobic yarn 3 are blown about violently and some monofilaments are disrupted from the hydrophilic yarn by the high velocity air streams in the air jet cavity. As a result of the tension, the monofilaments of the hydrophilic yarn 2 are caused to concentrate around the elastic filament 1 at, or near, the center of the composite yarn that exits the jet cavity 11 and the hydrophobic filaments are concentrated peripherally while an area, in which hydrophobic and hydrophilic fibers commingle, is created between the concentrations of the two fiber types.

When a thermoplastic fiber is texturized in an air jet or other texturing equipment, the fiber is heat set as it exits the texturing zone of the machine. FIG. 6 shows a heat setting assembly or cavity 12 just below the air jet cavity 11. Hydrophilic fibers produced from modified nylon polymers, however, may melt if exposed to heat setting temperatures commonly used for polyester based, as well as for some other, hydrophobic fibers. Consequently, it is necessary to minimize the temperatures and dwell times used to heat set the hydrophobic fibers when producing the composite yarns of the invention. For certain combinations of hydrophobic and hydrophilic fibers, it is not possible to properly heat set the hydrophobic component of the composite yarn without damaging the hydrophilic fiber. In such cases, it is possible to produce a good quality composite yarn by, first, texturing and heat setting the hydrophobic component and, then, running the pretexturized hydrophobic and the hydrophilic yarns through the air jet texturing equipment without applying temperature to the heat setting zone. Further, depending on the performance characteristics needed in the composite yarn, it can be preferable to pass both a non-texturized hydrophilic yarn and a hydrophobic yarn through the air-jet texturing machine without heat setting. This is particularly the case, if a very lightweight composite yarn is desired.

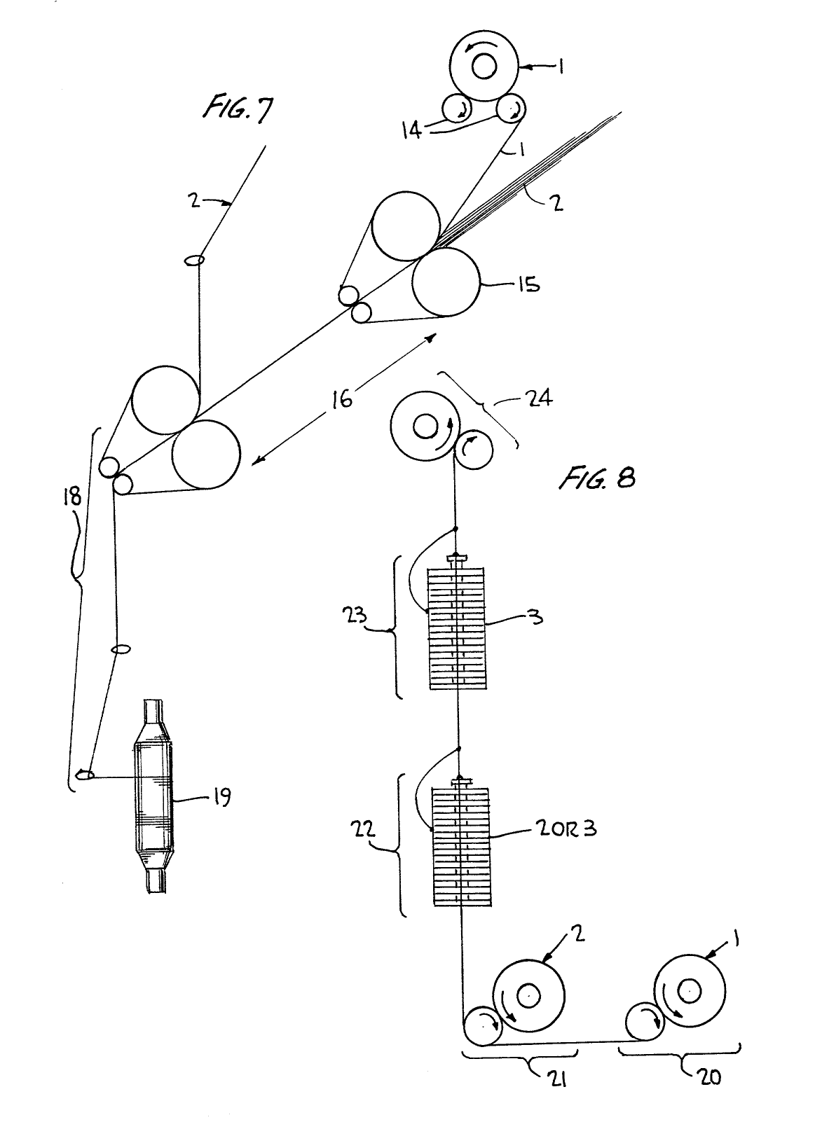

Cotton spinning frames may be utilized in producing the composite elastic yarns of the invention when the hydrophobic fiber is in a staple form. FIG. 7 is a simple schematic representing a cotton spinning frame with two core yarn feeding systems added. In the schematic, hydrophobic staple fibers 2 in sliver form are fed into the upper drafting apron of a cotton spinning frame. A positive drive assembly 14 feeds an elastic filament 1 at a constant stretch to the entrance of the upper drafting apron 15 along with the sliver. The elastic filament and the hydrophobic staple sliver are drawn in the drafting zone 16 between the upper 15 and lower 17 drafting aprons of the cotton spinning frame. A hydrophilic yarn 2 under tension is combined with the drafted hydrophobic fibers, 3 and the elastic filament at the entrance of the lower drafting apron 16. Forces generated in the twisting zone 18 cause the staple filaments to wrap about the hydrophilic yarn and the elastic filament. Since the elastic filament is under the most stretch of the three components, it migrates preferentially to the center of the resulting core spun yarn and is surrounded by the monofilaments of the hydrophilic yarn. The finished core spun yarn is taken up on a winding assembly 19.

Covering machines that normally are used to cover elastic filaments for use in women's hosiery and many other applications, also, are can be employed for the production fine denier composite elastic yarns of the invention. Such machines have been in use for covering natural and synthetic rubber threads, as well as spandex filaments, with a wide variety of fibers for more than 75 years. FIG. 8 presents a schematic sketch that shows typical pathways for spandex filament, hydrophilic yarn, and hydrophobic yarn in producing composite elastic yarns of the invention on elastic filament covering equipment. The sketch shows the elastic filament 1 fed from the positive drive assembly 20, while the hydrophilic yarn 2 is fed from a second drive assembly 21. Since the elastic filament is stretched to 100 percent elongation or higher, its positive drive assembly 20 runs at a linear speed that is 50 percent or lower than does the drive assembly 21 for the hydrophilic yarn. The elastic filament and the hydrophilic yarn under tension pass through one or two rapidly rotating spindles 22 and 23. These spindles are loaded with the hydrophobic yarn 3 which they wrap around the elastic filament 1 and the hydrophilic yarn 2 to form covers. If two covering layers are used, one is applied in an “S” direction (i.e., counter clockwise), while the other is wound in a “Z” direction (i.e., clockwise). This is accomplished by driving the spindles 22 and 23 in opposite directions. The winding assembly 24 takes up the finished composite elastic yarn on a bobbin.

In a conventional covering machine, it is possible to produce a unique composite elastic yarn of the invention. Such a yarn is produced by feeding only pre-stretched spandex 1 through the covering spindles with the lower spindle 22 loaded with a hydrophilic yarn 2 and the upper spindle 23 loaded with a hydrophobic yarn 3. The composite yarn that is wound on a bobbin by the takeup assembly 24 has an elastic core with an undercover of a hydrophilic yarn and an over-cover of a hydrophobic yarn.

It will be obvious to those skilled in the art that other processes and equipment can be utilized in the preparation of composite elastic yarns of the invention. For example, a pre stretched elastic filament along with a hydrophilic yarn can by provided with a cover of hydrophobic yarn by braiding or plying in a twister machine.

What is claimed is:

1. A composite textile elastic yarn comprising an elastic filament and hydrophilic fibers embedded substantially at the composite yarn center within a matrix of hydrophobic fibers, with the hydrophobic fibers concentrated at the periphery of the yarn, there being a transition area between hydrophilic fibers concentrated about the elastic filament at the yarn center and the peripherally concentrated hydrophobic fibers in which both fiber hydrophilic and hydrophobic fibers are present.

2. A composite textile elastic yarn, comprising at least 8 percent, but not more than 75 percent, by weight of a hydrophilic fiber and, at least 3 percent, but not more than 30 percent, of an elastic filament embedded within a matrix of one or more hydrophobic fibers, with the hydrophilic fibers and elastic filament positioned substantially at the yarn center, and the hydrophobic fibers positioned predominantly at the periphery of the yarn, there being a transition area between hydrophilic fibers concentrated about the elastic filament at the yarn center and the peripherally concentrated hydrophobic fibers in which both fiber hydrophilic and hydrophobic fibers are present.

3. A composite textile elastic yarn according to claims 1 or 2, wherein the elastic filament comprises spandex, the hydrophobic fiber comprises a flat or textured continuous filament yarn of polyester fiber, and the hydrophilic fiber comprises a flat or textured continuous filament modified 6-nylon or a spun staple yarn of a modified 6-nylon.

4. A composite textile elastic yarn according to claims 1 or 2, wherein the elastic filament comprises spandex, and the hydrophobic fiber comprises a flat or textured continuous filament yarn of polyester fiber, and the hydrophilic fiber comprises a flat or textured continuous filament or spun staple yarn of a modified 66-nylon.

5. A composite textile elastic yarn according to claims 1 or 2, wherein the elastic filament comprises spandex, the hydrophobic fiber comprises a staple yarn of polyester fiber, and the hydrophilic fiber comprises a flat or textured continuous filament modified 6-nylon or a spun staple yarn of a modified 6-nylon.

6. A plied yarn comprising the composite textile elastic yarn according to claims 1 or 2, and further comprising a hydrophobic yarn of essentially 100 percent hydrophobic fibers plied with the composite yarn.

7. A plied yarn, comprising the composite textile elastic yarn according to claim 6, and further comprising hydrophobic yarns each essentially 100 percent hydrophobic fibers plied with the composite yarn.

8. A composite textile elastic yarn according to claims 1 or 2 produced by feeding a flat or textured continuous filament hydrophobic yarn under tension along with an elastic filament stretched to, at least, 100 percent elongation into an air jet texturing device along with a flat or textured continuous filament hydrophobic yarn fed at a rate of at least 10 percent, but not more than 50 percent, greater than the feed rate of the hydrophilic yarn.

9. A moisture management elastic fabric made from the composite yarn according to claims 1, 2, or 3.

10. A two-faced moisture management elastic fabric or wearing apparel, comprising at least one hydrophobic yarn of essentially 100 percent hydrophobic fibers and the composite yarn according to claims 1, 2, or 3, the hydrophobic yarn being concentrated in a body contacting the fact of the fabric, and the composite yarn being concentrated in the outer face of the fabric.
